(19) United States
(12) Patent Application Publication
(10) Pub. No.: US 2017/0035648 A1
(43) Pub. Date: Feb. 9, 2017

(54) MASSAGE, ROTATING ATTACHMENT OR A MASSAGE METHOD

(71) Applicants: Tomas FRANK, Munchen (DE); Andreas FRANK, Offenbach am Main (DE)

(72) Inventor: Karlheinz FRANK, Offenbach am Main (DE)

(73) Assignees: Tomas FRANK, Munchen (DE); Andreas FRANK, Offenbach am Main (DE)

(21) Appl. No.: 15/228,857

(22) Filed: Aug. 4, 2016

(30) Foreign Application Priority Data
Aug. 6, 2015 (DE) 102015010326.1

(51) Int. Cl. A61H 15/00

(52) U.S. Cl. CPC A61H 15/0092; A61H 2015/005; A61H 2015/0014

(57) ABSTRACT

The present invention concerns a rotating attachment, in particular for purposes of massage, which comprises a rotating mechanism with at least one rotating axle/rotation axis. This rotating axle can be connected with a drive or can be readily inserted into a plug connector, coupling or chuck or be secured and/or connected in a torque-proof manner. Furthermore, at least one massage head with at least one massage axle is provided for. In each case, at least one roll that can be rotated around the massage axle can be provided for at and/or on the massage axle. The massage head, the massage axles and/or the rolls are arranged such that the rotating axle and each of the massage axles are arranged in different planes and/or the massage axle(s) and/or the roll(s) are at least partially laterally tilted and/or deviated with reference to the rotating axle in one component.

### CROSS-REFERENCE TO RELATED APPLICATIONS

This application claims the benefit of German Application No. 102015010326.1, filed Aug. 6, 2015, in the German Patent and Trade Mark Office. All disclosures of the document(s) named above are incorporated herein by reference.

### TECHNICAL AREA

The present invention relates to a massage and/or rotating attachment and/or a massage method, in particular for treating and manipulating muscles, fasciae and skin, in particular to stimulate nerves and nerve cells of all the parts of the body.

### Introduction

Various mechanisms and/or attachments for purposes of massage are known. Among them are electric motor driven massage devices that exclusively carry out vibrating, rotating, vertical and/or horizontal and/or similar movements, which generally require lubricating, massage or slip agents in order to protect the skin from irritations and/or injuries during treatment.

DE 200 01 928 U1 refers to a device for massaging the skin and the tissue under the skin. In this device, the massage heads are permanently connected with the massage head holder in the form of balls, which leads to injuries of the skin, in particular rash, if no oils, massage or slip agents are added.

Furthermore, a massage device with a graspable main body is described in WO 2014/189096. At least three rotating and revolving bodies are attached to same.

WO 2014/054450 A1 describes a cosmetic rotating mechanism for applying cosmetics, to an arm, for example. Here, two rolls are affixed to the device at an angle.

CN 20340821 89 U shows a rotating massage device with three revolving balls extending radially from a rotary shaft. The rotary shaft can be mounted in a conventional drive unit.

JP 2011 041718 A shows a hand-held massage device. Here, two roll mechanisms are attached to a handle, more precisely, to two axles affixed to the handle. These axles initially run apart divergently by approx. 90 degrees, and then together again convergently at a smaller angle. Rolls, which are spaced apart, are arranged on the free sides. This hand-held device is intended to ensure ease of handling.

The disadvantage of the known devices is that the devices generally exhibit less efficacy and/or are operated with oils, massage or slip agents and can exclusively carry out two-dimensional movements and that the manufacture of such devices is associated with high costs of tools and production as well as that the devices are difficult to manufacture and mount.

The present invention is intended to provide an alternative and/or advantageous massage and/or rotating attachment and an alternative and/or advantageous massage method.

### SUMMARY OF THE INVENTION

The invention is presented in the description and/or the claims, in particular the independent claims. It concerns a massage and/or rotating attachment and/or a massage method, in particular to treat and manipulate muscles, fasciae and/or the skin, to stimulate nerves and nerve cells of all parts of the body.

Further constructions and features of use of the massage device and method are presented in the sub-claims.

The features of various claims and embodiments described can be combined with each other, even if such combinations are not explicitly mentioned.

The present invention concerns a rotating attachment, in particular for purposes of massage, which comprises a rotating mechanism with at least one rotating axle/rotation axis. This rotating axle can be permanently connected to a drive or become so and/or can be provided for and constructed such that it can be readily inserted into a plug connector, coupling or chuck or be secured and/or connected in a torque-proof manner. In one embodiment, it comprises a hexagon that is equivalent or similar to a tool bit so that it can be readily inserted into a corresponding rotating device such as a cordless screwdriver or an electric drill. The rotating axle can be suited for turning the rotating attachment around the rotating axle.

Furthermore, the rotating attachment according to the invention can be turned by a hydraulic drive. The driving effect can be produced by water in a shower hose such that the resulting water pressure turns a correspondingly constructed rotating mechanism which drives the rotating attachment. Together with the shower water, a special massage function can thus be ensured. Furthermore, mechanisms for further support of the rotation, such as gas capsules, can be provided, in particular to enable sufficiently strong and/or rapid rotation in the case of weak water pressure.

Moreover, at least one massage head with at least one massage axis/massage axle can be provided for. In each case, at least one roll that can be rotated around the massage axle can be provided for at and/or on the massage axle. Axle locking mechanisms or bends at the massage axles can be present, which are not presented in detail. This can, in particular, prevent slipping or axial shifting of the roll(s) on the massage axle(s). Furthermore, the massage axles can be tilted and/or oriented such that, when the massage head rotates in the operating direction of rotation, rolls which can be floating, can be pressed to the fixed end of the rotating axles by centripetal force so that they do not require any fixation.

Merely for the purpose of safety, securing means can be present at the free ends in order to prevent the rolls from falling out, particularly when the device is not in operation.

Here, the term roll refers to every rotating element with symmetric rotation, such as rollers, rolls, balls or cones, as well as elements that do not rotate symmetrically or a combination of same.

The rotating axle and each of the massage axles can be arranged in different planes and/or at different angles. Here, the rotating axle and/or the massage axles are in planes that are not the same and are not parallel to each other.

Additionally, or alternatively, the massage axle(s) and/or the roll(s) is/are laterally tilted, pivoted and/or deviated with reference to the rotating axle at least partially in one component. Therefore, the massage axles are not parallel to each other or to the rotating axle. They can also be at least partially tilted to the inside with reference to the rotating axle in one component.

The massage head can comprise two massage axles, and at least one rotating roll can be provided for each massage axle in each case.

Furthermore, the massage axles and/or the rolls can be aligned in a similar, preferentially the same and/or a homogeneous orientation. Here, the massage axles can have the same positions and/or orientations with a rotation at an angular distance.

Two massage axles can be provided for, where such axles and/or the rolls cross each other in a first position and in a plane of the rotating axle in a first lateral view in at least one section. Furthermore, they can lie next to each other or be spaced apart in one plane of the rotating axle in a second position, which is rotated by 90 degrees with reference to the first position, in at least that section.

The rotating attachment can cross at least two of the massage axles and/or rolls in a crossing section in a lateral projection parallel to the rotating axle. In this crossing section, one projected opening angle β each to the outside can be in a range of at least 90 degrees, preferentially at least 100 degrees, furthermore preferentially at least 110 degrees, furthermore preferentially at least 120 degrees, and/or a maximum of 170 degrees, preferentially a maximum of 160 degrees, furthermore preferentially a maximum of 150 degrees, furthermore preferentially a maximum of 140 degrees and especially preferentially around 130 degrees in each case.

The rotating attachment can comprise at least two massage heads, the rotating axles of which are essentially parallel to each other and the massage heads of which move such during operation that they intermesh.

The massage axle(s) and/or roll(s) can be arranged such that they are articulated and/or cushioning. This can be caused by changes in materials and/or properties in and/or at the rotating axle and/or the massage axles. Thin points and/or trimmed points in axles made of plastic is one of numerous possible examples.

The rolls can be springy and/or be mounted on bearings such that they are springy. As a result, contours can be massaged gently.

The rotating mechanism and/or rotating axle can be constructed as a quick-release axle for an automatic drive, such as a hydraulic, pneumatic, electric drive and/or springs that are put on manually.

An embodiment in and/or on a shower hose has already been mentioned previously. A hydraulic drive mechanism that is driven at least partially by water in a hose can be provided for by a special device such as, for example, a hydraulic drive device for a shower hose. It can use built-in impellers and/or any other mechanisms that convert water pressure into a rotational movement. The rotational force and speed of rotation can be regulated by the amount of water and/or the supply of air or other gases for the envisaged purposes of massage. The latter can be accomplished by compressed gas cartridges that can be connected to the shower hose.

The massage axle and/or the rolls can be embodied straight. Alternatively, or additionally, the massage axles can be embodied with straight sections and wholly bent with at least one massage axle and at least one roll. Furthermore, they can be embodied in the shape of a corkscrew.

Additionally, or alternatively, at least two of the massage axles can be connected to each other at the end opposite from the rotating axle. This increases the stability of the overall structure.

Furthermore, rotating mechanisms and/or rotating axles can be provided for on the massage head in order to achieve bilateral support. That would be advantageous, e.g. in the case of massage heads for massaging the neck muscles.

The massage head, the massage axle and/or the roll can be arranged such that they at least partially describe an envelope during rotation operation which initially converges from the end located proximal to the direction of rotation and then diverges towards a distal end in the further course of operation. As a result, the envelope can describe a central area or an area that centers itself with the smallest diameter of rotation, from which larger diameters of rotation of the envelopes are arranged bilaterally. In particular, therefore, all kinds of extremities can be massaged effectively without a greater effort having to be made to hold the massage head in the most effective position.

Furthermore, as a result of this arrangement, a mild or, depending on the construction and arrangement of the massage axles and rolls, stronger knocking and/or beating motion on the tissue or the extremity is carried out on the one hand. However, the roll or rolls roll along or on the tissue or the extremity after the first contact, which is able to prevent further strain on the tissue or the extremity and/or their surfaces. In summary, thus, the invention can simultaneously effect a knocking and a rolling massage and, while doing so, make operation even easier for the user.

The free rotation of the rolls can be decelerated and/or stopped. This can be done by mechanical, geometrical, physical and/or chemical means. The decelerated and/or stopped rotation of the rolls effects a further drumming motion of the tissue during rotation, because the roll or rolls do not simply roll on the skin, but rather also slide and/or carry out a drumming motion on the skin and/or tissue.

The invention concerns, in particular, an essentially fork-shaped rotating attachment with at least one or more massage heads, which is connected operatively with an electric motor drive or other drive via a drive shaft and a rail head by means of a driving feature. In this context, the rotating attachment and/or the massage head is driven by the rotating motion of the electric motor drive or other drive via the drive shaft as well as a rail head and/or the rotating axle as well as a driving feature and put into a rotating motion.

As a result, the rotating attachment will put the muscles, fasciae, skin and/or nerves and nerve cells into a three-dimensional orbital motion (3D motion) at the place to be treated. The massage head(s) can be embodied such it/that they is/are displaced eccentrically and/or asymmetrically and diametrically or concentrically and/or symmetrically. As a result, the rolls that are put into rotation at the place to be treated effect a gentle and sparing manipulation and/or stimulation of the muscles, fasciae and skin as well as stimulation of the nerves and nerve cells of the parts of the body being treated with the use of at least two or more rolls, e.g. rollers, balls or cones and/or similar shapes or a combination of same, without the additional use of lubricating, massage or slip agents. Furthermore, this loosens hardened muscles and adhesions/knots of the fasciae and/or promotes circulation in the skin or, in particular, protects the skin from irritation and injury in accordance with the use for stimulation of the body.

In the case of electric motor driven massage devices, in particular in the case of devices for the treatment of muscles, fasciae and the skin, it has proven to be advantageous to have the vibrating, rotating, vertical and/or horizontal and/or similar motions obtain an additional motion in a third axis and/or axle.

The massage head comprises at least two massage axles. Three or more massage axles can also be present, depending on the desired effect and/or costs of manufacture. At least one rotating roll is provided for each massage axle in each case. However, depending on the massage axle, multiple rolls can also be present, in particular if the massage axles are not embodied wholly straight, but rather are slightly bent, merely have straight sections or comprise both.

Alternatively, or additionally, the rotating attachment can comprise a rotating mechanism with a rotating axle that is suited for turning the rotating attachment around the rotating axle. In this context, at least one massage head with at least two massage axles and at least one roll that can be rotated around each massage axle can be provided for. The massage axles and/or the rolls can cross the massage axles and/or the rolls in a first position and in a plane of the rotating axle in a first lateral view in at least one section and be arranged adjacent or spaced apart in one plane of the rotating axle at a second position that is rotated by 90 degrees with reference to the first position in at least the section. This can be an efficient possibility for representing the previously described envelope. The distance in the second position then determines the knocking massage effect together with the other geometric conditions such as the diameters of the rolls.

The rotating attachment comprises at least two massage heads, the rotating axles of which essentially run parallel, towards each other or away from each other and the massage heads of which move such that they intermesh during operation.

The rotating mechanism can have one opening angle (11) each to the outside in the crossing section in the convergent area of the envelopes and/or in the first lateral view, with such angle being at least 90 degrees, preferentially at least 100 degrees, furthermore preferentially at least 110 degrees, furthermore preferentially at least 120 degrees, and/or a maximum of 170 degrees, preferentially a maximum of 160 degrees, furthermore preferentially a maximum of 150 degrees, furthermore preferentially a maximum of 140 degrees and especially preferentially approximately 130 degrees. As a result, in particular, a self-centering effect for extremities taking place during the massage is achieved.

Additionally, the rotating mechanism can represent a quick-release axle for an automatic drive such as an electric motor and, in particular, a battery-powered rotating mechanism such as a cordless drill/screwdriver.

The rotating axle can also be permanently connected with an automatic rotating mechanism such as an electric motor.

The massage axle and/or the rolls can be embodied straight. In particular, the massage axles can have straight axle sections on which the rolls are arranged. The rolls can consist of any suitable material or comprise equally straight and/or differently shaped surfaces. In particular, suitable materials are skin-friendly and/or elastic. Materials of this kind can comprise plastics, woven and non-woven fibers, fleeces, silicones, caoutchouc, cotton, polyamide, nylon, latex, rubber, leather, wood and/or mixed forms of same.

The massage axles can be embodied with straight sections or wholly bent and with at least one roll provided for every straight section of a massage axle.

At least two of the massage axles at the end opposite the rotating axle can be connected to each other. This would result in a shape that would each describe an envelope with a larger diameter and, in between, with a smaller diameter proximally and distally to the rotating mechanism. All the rotating axles or individual ones could then be connected to each other at the proximal and/or distal end. The massage head can describe an envelope during rotation that forms a double cone that is tapered in a middle area.

The invention likewise concerns a massage method that makes use of or uses one or more of the features of the device described in the foregoing or following.

Accordingly, a massage method is encompassed where a rotating mechanism with a rotating axle that is suited for turning the rotating attachment around the rotating axle is turned. At least one massage head with at least one massage axle, in particular of the shapes and kinds as described, is provided for. Furthermore, at least one roll, in particular of the shapes and kinds as described, that can be rotated around a massage axle is provided for in each case. In this context, the rotating axle and each of the massage axles can be arranged in different planes and/or the massage axle and/or the roll can be laterally tilted and/or pivoted and/or deviated with reference to the rotating axle at least partially in one component.

Additional aspects and/or advantages of the invention will be set forth in part in the description which follows and, in part, will be obvious from the description, or may be learned by practice of the invention.

### BRIEF DESCRIPTION OF THE DRAWINGS

Examples of embodiments of the invention, which are by no means final, are shown in the drawing and described in more detail subsequently.

FIG. 1 shows a rotating attachment with a rail head and electric motor drive or other drive according to the invention that is embodied with rolls.

FIG. 2 shows another rotating attachment with a massage head, the massage axles and rolls according to the invention.

FIG. 3 shows another rotating attachment without depicted rolls and with massage axles that are connected to each other at both ends according to the invention.

FIG. 4 shows another rotating attachment without rolls with additional, different massage axles that are aligned differently and with homogeneous orientation according to the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The fork-shaped rotating attachment 1 shown in FIG. 1 has two massage axles 2 that are driven by an electric motor drive or other drive 7 via a drive shaft 6 and a rail head 5 by means of a rotating axle 4. This is preferentially constructed as a hexagon and has operative connection with the rotating attachment 1. It can be plugged into and/or mounted on the rail head 5 and/or be permanently connected with same. The massage axles 2 extend from the rotating axle 4 and a transverse holder under an angle a (alpha). In this area (not shown) non-springy and/or springy materials can be provided for in order to make a certain degree of resilience possible. In the perspective shown, the crossing of the massage axles 2 and/or the rolls 3, in particular, can be recognized.

The rotating attachment 1, which is driven and put into a rotating motion by the rotating motion of the electric motor drive or other drive 7, which is driven via the drive shaft 6 and the rail head 5 as well as by the rotating axle 4 and put into a rotating motion, puts muscles, fasciae, skin and/or nerves and nerve cells into a three-dimensional orbital motion (3D motion) and achieves its effect as a result of at least two or more massage axles 2 being at an angle a of 90 degrees or smaller than 90 degrees. In this context, the at least two or more massage axles 2 serve as carriers for the at least two or more massage heads 2,3 and/or rolls 3, which can be embodied such that they are offset eccentrically and/or asymmetrically and diametrically or are concentrical and/or symmetrical. The massage axles 2 and/or rolls 3 are interlocked, but without the rolls 3, of which there are at least two or more, touching against each other, and/or touching, in order to achieve a greater 3D effect. Thus, an angle β (beta) of the two or more massage axles 2 of 180 degrees or smaller with reference to each other is formed.

The at least two or more massage axles 2 are put into rotation in order to achieve gentle and sparing manipulation and/or stimulation of the muscles, fasciae and skin as well as stimulation of the nerves and nerve cells of all the parts of the body being treated and to relax stiff muscles, loosen adhesions/knots of the fasciae and/or to promote circulation in the skin or to stimulate the body in accordance with the use, in particular to protect the skin from irritation and injury, by using at least two or more specific rolls 3, e.g. rollers, rolls, balls or cones and/or similar shapes or a combination of same, without the additional use of lubricating, massage or slip agents.

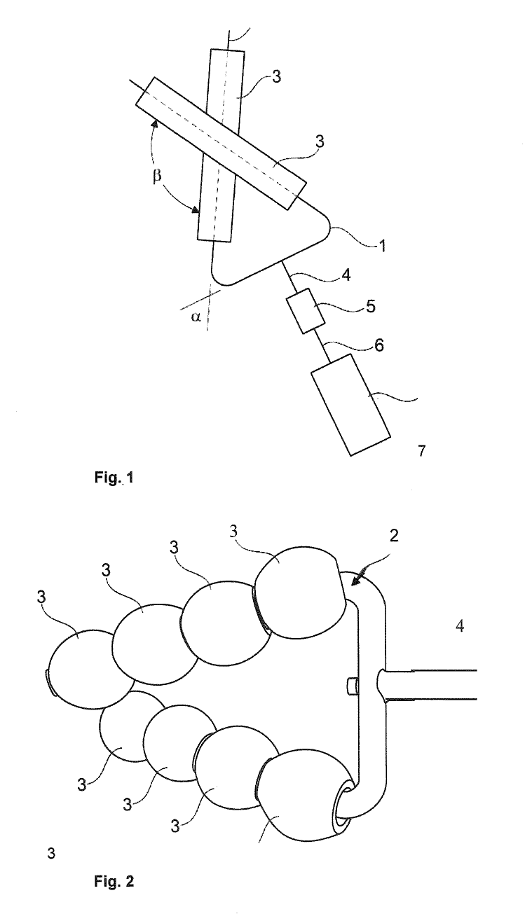

FIG. 2 shows a massage head 2,3 with massage axles 2 and rolls 3. Two massage axles that are tilted with a homogeneous orientation can be provided for. In this context, they run under each other and also to the rotating axle 4 in different planes. The orientation can be such that they cross each other in a perspective with the rotating axle 4 in the paper plane and run away divergently from the part of the massage axle pointing to the rotating axle 4 in a position that is pivoted by 90 degrees. Due to the centripetal force, the rolls are pressed in the direction of the rotating axle 4 and/or the closed and/or connected end of the massage axles 2 and thus positively prevented from falling out during rotation. Therefore, protection can be provided for at the free end of the rotating axles 4 merely as a precaution. Rolls 3 can be made of the materials determined previously. In this context, the shape of the rolls can be more or less ball-shaped or approximately ball shaped as shown. Depending on the purpose of massage, other shapes are also suitable, as already explained.

The rotating axle 4 can be embodied uniformly with the massage axles 2 or be attached to same by a connecting element such as a screw.

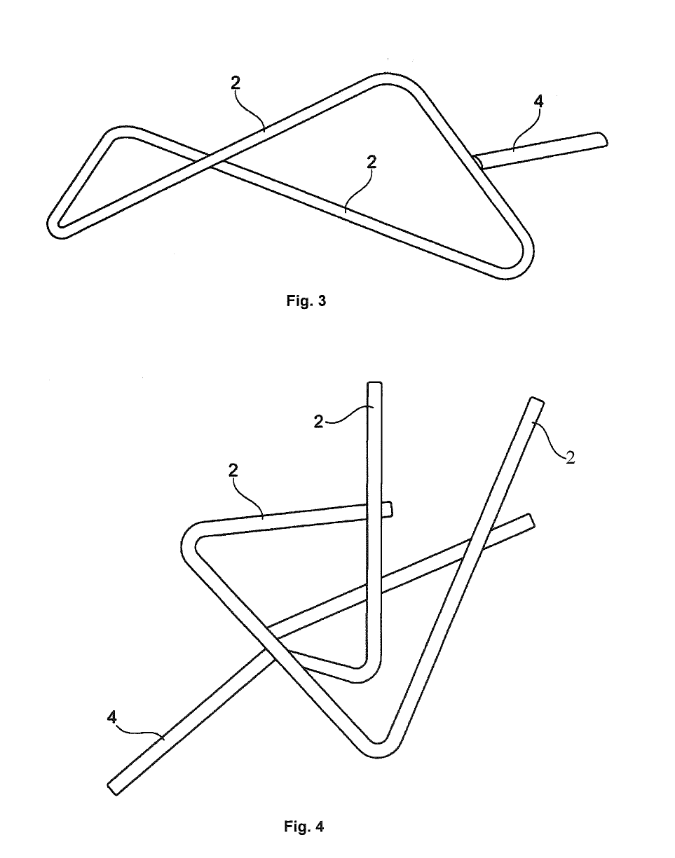

FIG. 3 shows only schematically a rotating attachment with a rotating axle 4 and massage axles 2 connected with same according to the invention. These massage axles 2 can also be connected to each other at the opposite end as shown. That is also possible in the case of rotating attachments with multiple massage axles 2. Rolls are not shown in the interest of simplification, but they can be present as diverse forms, kinds and arrangements in order to rotate around the massage axles 2 either decelerated and/or stopped and/or not decelerated and/or stopped.

Furthermore, another rotating axle (not shown) that should be aligned with the depicted rotating axle 4 can be provided for at the aforementioned connection.

FIG. 4 shows a rotating attachment with four massage axles 2 according to the invention. Less or more than four massage axles 2 can be provided for. Rolls are not shown in the interest of simplification, but can be present as diverse forms, kinds and arrangements in order to rotate around the massage axles 2 either decelerated and/or stopped and/or not decelerated and/or stopped The rotating attachment describes a structure with envelopes running together and then apart again during the rotation at least partially, with the individual massage axles 2 and rolls 3 executing a slightly knocking motion. The massage axles 2 shown in the depicted embodiment can also be connected to each other at their free ends wholly or partially.

In the case of individual massage heads or multiple massage heads meshing with each other, all of the elements or individual elements such as the massage axles 2, can be constructed flexibly and/or articulated at their ends in order to be resilient. In this context, these structures can be produced by springs, certain materials or shapes.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A rotating attachment, comprising:
a rotating mechanism with at least one rotating axle to turn the rotating attachment around the at least one rotating axle;
at least one massage head with at least one massage axle;
at least one case in which at least one roll is rotatable around the at least one massage axle,
wherein:
the at least one rotating axle and each of the massage axles are arranged in different planes; and/or the at least one massage axle and/or the at least one roll are laterally tilted and/or pivoted with reference to the at least one rotating axle at least partially in one component.

2. The rotating attachment according to claim 1, wherein the at least one massage axle and/or the at least one roll are tilted to an inside of the at least one rotating axle at least partially in one component.

3. The rotating attachment according to claim 1, wherein:
each massage head comprises at least two massage axles and at least one rotating roll in each case for each massage axle; and/or
the massage axles and/or the rolls are aligned with a homogeneous orientation.

4. The rotating attachment according to claim 1, wherein with the at least one massage comprises two massage axles, the massage axles and/or the rolls crossing each other in a first position and crossing the massage axles and/or the rolls in at least one section in a plane of the at least one rotating axle in a first lateral view in at least one section and lying next to each other, touching each other or spaced apart in a plane of the at least one rotating axle in a second position rotated by 90° with reference to the first position in at least the section and/or with at least two of the massage axles and/or rolls crossing each other in a lateral projection parallel to the at least one rotating axle in a crossing section.

5. The rotating attachment according to claim 1, wherein the at least one roll comprises two rolls, and a projected opening angle β of the two rolls is a value to in a range of at least 90 degrees and a maximum of 170 degrees in the crossing section.

6. The rotating attachment according to claim 1, wherein the at least one massage head comprises at least two massage heads, the rotating axles of which are parallel to each other or run towards each other or away from each other, and the massage heads move such that they intermesh during operation.

7. The rotating attachment according to claim 1, wherein the at least one massage axle and/or the at least one roll are arranged articulated and/or cushioning and/or a free rotation of the least one roll being decelerated and/or stopped and/or the at least one rolls is springy and/or mounted on bearings so as to be springy.

8. The rotating attachment according to claim 1, further comprising an automatic drive and/or a hydraulic drive driven by water in a hose, which is supported by supplied air or gas.

9. The rotating attachment according to claim 1, wherein the at least one message axle is plural in numbers and the massage axles and/or the rolls are straight and/or with straight sections and/or wholly bent and/or in the shape of a corkscrew.

10. The rotating attachment according to claim 9, wherein at least two of the massage axles are connected to each other at the end opposite the at least one rotating axle and/or the at least one rotating axle comprises two rotating axles that are opposite each other.

11. A massage method, comprising:
turning a rotating mechanism with at least one rotating axle around the rotating axle; and
driving at least one massage head with at least one massage axle and at least one roll that is rotatable around the at least one massage axle;
wherein:
the at least one rotating axle and each of the massage axles are arranged in different planes; and/or
the at least one massage axle and/or the at least one roll are laterally tilted and/or pivoted at least partially with reference to the at least one rotating axle in one component.
